(19) United States
(12) Patent Application Publication
(10) Pub. No.: US 2005/0002606 A1
(43) Pub. Date: Jan. 6, 2005

(54) Optical transmission device

(76) Inventors: Stephen Wayne James, Buckinghamshire (GB); Ralph Peter Tatam, Wellingborough (GB)

Correspondence Address: CARSTENS YEE & CAHOON, LLP, P O BOX 802334, DALLAS, TX, 75380, US

(21) Appl. No.: 10/490,137

(22) PCT Filed: Sep. 19, 2002
(86) PCT No.: PCT/GB02/04291

(30) Foreign Application Priority Data
Sep. 19, 2001 (GB) 0122546.5

(51) Int. Cl. G02B 6/26

(52) U.S. Cl. 385/31; 385/37

(57) ABSTRACT

A device comprising an optical waveguide incorporating a long period grating and a thin film overlay material is described. The wavelength transmission spectrum of the device is fonctionally dependent upon the optical properties and thickness of the overlay material. If the overlay material has a refractive index higher than that of the cladding material surrounding the guiding layer of the waveguide, appropriate choice of thickness allows the sensitivity of the transmission spectrum of the device to changes in the optical properties of the overlay material to be enhanced. Appropriate choice of material thus allows voltage or optical or chemical or thermal, or any combination thereof, control over the transmission spectrum. The device may be used to form a tunable spectral filter, sensor or optical switch.

This invention relates to an optical transmission device. More particularly, but not exclusively, it relates to an optical fibre long period grating with a thin film overlay. Even more particularly, but not exclusively, it relates to devices that may be fabricated via the deposition of thin films of organic or inorganic materials onto an optical fibre containing a long period grating (LPG).

The devices thus formed may have practical applications in at least the following non-exclusive list: temperature sensors, tunable spectral filters, amplitude modulators, chemical sensors, voltage sensors and optical switches.

A long period grating (LPG) is a periodic modulation of the optical properties of an optical waveguide, typically an optical fiber. This periodic perturbation of the optical properties of the optical fibre, or other optical waveguide, is typically achieved by exposing the waveguide to ultraviolet radiation with a periodic pattern, the bombardment of the waveguide with ions, for example H⁺ or He^{+, 2+}, or the modification of the shape of the waveguide. The LPG acts to couple light from the propagating core mode to co-propagating cladding modes at discrete wavelengths. The in-line transmission spectrum of a LPG consists of a series of attenuation bands, with the central wavelengths of the attenuation bands showing a dependence upon the local environment experienced by the fibre. These attenuation bands are typically 10 nm wide and the centre of the bands is known to vary with perturbation of the waveguide structure such as the application of strain or the bending of the waveguide. The attenuation bands exhibit a shift in their central wavelengths when intimately surrounded by thick layers of materials with refractive index lower than that of the cladding of the optical fibre. For materials of refractive higher than that of the cladding, the central wavelength of the attenuation bands is essentially unaffected.

LPGs have been characterised as channel dropping filtersⁱ and as sensors for strain, temperatureⁱⁱ, bend radiusⁱⁱⁱ and refractive index^{iv}. The dependence of the central wavelengths of the attenuation bands upon the refractive index of the medium surrounding the fibre has allowed LPGs to be characterised as sensors for the external surrounding environment^{iv}. The response of the LPG transmission spectrum to bulk immersion in refractive index liquids has been reported and may lead to applications as liquid-level sensors^{v} or chemical concentration sensors^{vi} in hazardous or inaccessible environments. This effect has been exploited to form sensors capable of measuring the refractive index of a solution, allowing concentrations of sodium chloride and ethylene glycol to be determined^{vi}. Such sensors are not chemical species specific, and are limited to operation with solutions with refractive indices less than or equal to the refractive index of the fibre cladding. Liquids of refractive index higher that of the cladding cause no change in the central wavelengths of the attenuation bands, but may cause an increase in the minimum transmission of the attenuation bands. Of more interest is the potential to deposit overlay materials that exhibit changes in their refractive index in response to their local environment. In this way, the LPG could form, for example, a tuneable loss filterⁱ, a temperature insensitive filter^{vii} or a species-specific chemical sensor^{viii}.

A LPG consists of a period modulation of the optical properties of an optical waveguide, typically an optical fiber. The periodicity lies typically in the range 100 μm to 1000 μm. The LPG acts to couple light from the propagating core mode to co-propagating cladding modes. Since the cladding modes suffer from high attenuation, the transmission spectrum consists of a series of attenuation bands centred on wavelengths given by
λᵢ=[n_{eff}(λᵢ)−nⁱ_{clad}(λᵢ)]Λ (1)
where λi is the coupling wavelength, neff is the effective index of the propagating cladding mode, n(i)clad is the index of the with cladding mode, and Λ is the period of the LPG. The refractive index sensitivity of the coupling wavelength arises from the dependence of the cladding mode's effective refractive index upon the refractive index of the surrounding material. The cladding can typically support a number of modes due to the large dimensions of the cladding, typically of the order of 100 μm diameter but can be smaller than this.

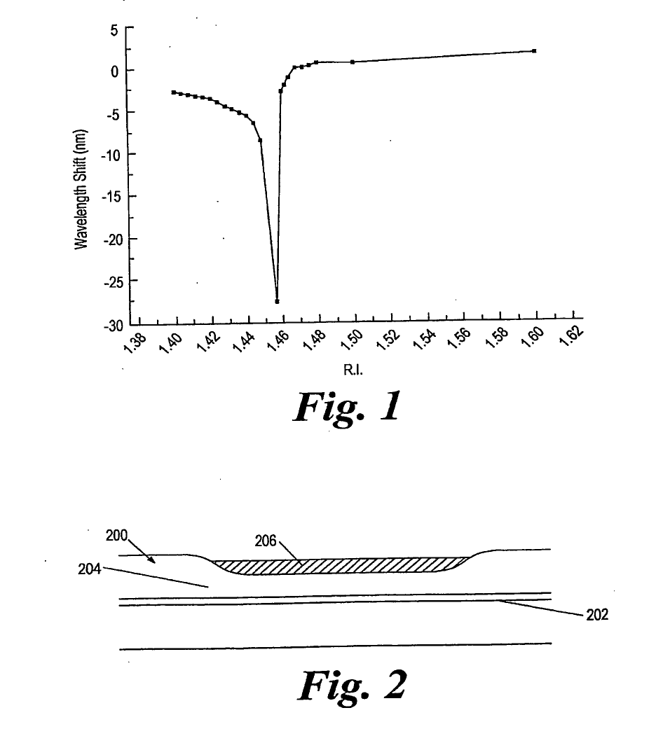

A LPG of length 40 mm, period 400 μm, fabricated in boron-germania co-doped optical fiber (Fibercore PS750) with cut off wavelength 650 nm was submerged in a series of external media of different refractive indices. FIG. 1 shows the bulk external medium refractive index induced wavelength shift of the central wavelength of an attenuation band in the spectrum. The figure shows that the response to refractive index occurs over range of approximately 1.400 to 1.456. The upper limit is imposed by the refractive index of the cladding material. For refractive indices above this limit there is no wavelength response. This appears to place a limit upon the range of overlay materials that may be deposited upon the optical fiber to form sensors and modulators and tunable filters.

A prior art waveguide 200 is shown in FIG. 2 in which a core 202 is enclosed in a cladding 204. A section of the cladding 204 is removed such that there is access to the evanescent field of a mode propagating in the core 202. An overlayer 206 is deposited onto the cladding such that the overlayer forms a waveguide. Coupling can take place between the core 202 and the overlayer waveguide 206 at a wavelength that is dependent upon the refractive index and thickness of the overlayer 206 such that the transmission spectrum of the core 202 contains an attenuation band. This arrangement suffers from losses that depend upon the absorption spectrum of the overlayer material.

According to an aspect of the present invention there is provided an optical transmission device comprising a core and a cladding, the cladding substantially enclosing the core over substantially all of the length of the core, the core being arranged to transmit radiation therealong and comprising coupling means therein arranged to selectively couple at least one wavelength of radiation into the cladding, an overlayer extends over at least a region of the cladding, and wherein the at least one wavelength of radiation arranged to be coupled into the cladding from the core varies as the thickness and/or refractive index of the overlayer is varied.

The coupling means may be a long period grating (LPG). The overlayer may extend over a region of the cladding adjacent the coupling means.

The invention exploits a recently observed effect in which the transmission spectrum LPGs have been shown to exhibit sensitivity to the optical properties of thin films (thickness less than or approximately equal to 1 μm) of material surrounding the fibre when the material has a refractive index higher than, or equal to, that of the cladding of the optical fibre. It is shown that the central wavelengths and the minimum transmission of the LPG attenuation bands exhibit a dependence on both the thickness and refractive index of such an overlay material.

The operation of these devices is based upon a new effect observed when thin films of materials of refractive index higher than that of the cladding of the optical fibre are deposited upon an optical fibre containing a long period grating. The form of the transmission spectrum of the LPG is sensitive to changes in the properties of the overlay material, in particular its refractive index and thickness. Appropriate choice of overlay material allows a number of devices to be realised. Electro-optic overlay materials that exhibit changes in refractive index in response to an applied electric field may be used to construct voltage tunable optical filters, voltage sensors or electrically controlled optical switches. Materials that display changes in their absorption spectrum, and thus refractive index, upon exposure to particular chemical species, may be used to construct chemical sensors, chemically tuned optical filters, or a chemically controlled optical switch. Photochromic materials may be used to form optically controlled tunable filters, light sensors and optically controlled optical switches. Materials that change their physical dimensions in response to an external stimulus may be used to construct a sensor to measure the stimulus, or to form tunable optical filters, or to form an optical switch. Materials having thermo-optic coefficients may be used to form temperature sensors, thermally controlled tunable filters and thermally controlled switches, or used to athermalise the response of the LPG spectrum.

The thickness of the overlayer may vary along the length of the region of the cladding. The refractive index of the overlayer may vary along the length: of the region of the cladding. Such an arrangement has the advantage that the attenuation bands associated with the LPG will be broader than if the thickness/refractive index of the overlayer is constant over it's length. This is because different wavelengths of radiation will be coupled from the core into the cladding at different points along the length of the region.

The overlayer may be an electro-optic material. Where the-overlayer is an electro-optic material and the thickness of overlayer varies along the region there may be provided a plurality of electrical contact points to the overlayer along the length thereof. This arrangement allows the overlayer to be addressed such that the refractive index of the overlayer can be altered at a specific point in order to couple a known wavelength of radiation into the cladding from the core.

Alternatively, or additionally, the thickness of the cladding may vary with respect to time. In a further alternative, or addition, the refractive index of the cladding may vary with respect to time. Such a variation of the thickness, or more particularly, the refractive index of the overlayer with respect to time allows the application of the device in a range of diverse applications, for example, sensing, optical modulation and filtering.

There may be provided a plurality of coupling means. The overlayer may be disposed between two of the plurality of coupling means. This introduces fine structure into the attenuation bands due to interference effects, which allow the formation of high-resolution devices, for example sensing, optical modulation and filtering devices.

The overlayer may have a refractive index that varies in response to an external perturbation that changes a property of the film.

According to a second aspect of the present invention there is provided a method of coupling radiation from a core of an optical transmission device into a cladding of the device comprising the steps of:
i) enclosing the core in the cladding over substantially all of the length of the core;
ii) transmitting radiation along the core;
iii) coupling at least one wavelength of radiation into the cladding from the core using coupling means; and providing an overlayer that extends over a region of the cladding such that the at least one wavelength of radiation varies as the thickness and/or refractive index of the overlayer varies.

According to a third aspect of the present invention there is provided a sensor including an optical transmission device according to the first aspect of the present invention.

According to a fourth aspect of the present invention there is provided a sensing arrangement including a radiation source, a radiation detector and a sensor according to the third aspect of the present invention, the radiation source being arranged to emit radiation at the at least one wavelength of radiation and the radiation detector being arranged to detect radiation at the at least one wavelength of radiation.

According to a fifth aspect of the present invention there is provided an optical modulator including a device according to the first aspect of the present invention.

According to a sixth aspect of the present invention there is provided an optical modulation arrangement including a radiation source, a radiation detector and an optical switch according to the fifth aspect of the present invention, the radiation source being arranged to emit radiation at the at least one wavelength of radiation and the radiation detector being arranged to detect radiation at the at least one wavelength of radiation.

According to a seventh aspect of the present invention there is provided a tuneable filter including an optical transmission device according to the first aspect of the present invention.

According to an eighth aspect of the present invention there is provided an optical waveguide including an optical transmission device according to the first aspect of the present invention

The optical waveguide may be an optical fibre.

The invention will now be described, by way of example only, with reference to the accompanying drawings in which:

FIG. 1 is a graph showing the external medium refractive index induced wavelength shift of the central wavelength of the attenuation band corresponding to coupling to the 6^{th} cladding mode, the line is a guide to the eye (of the prior art);

FIG. 2 is a schematic diagram of an overlay waveguide of the prior art;

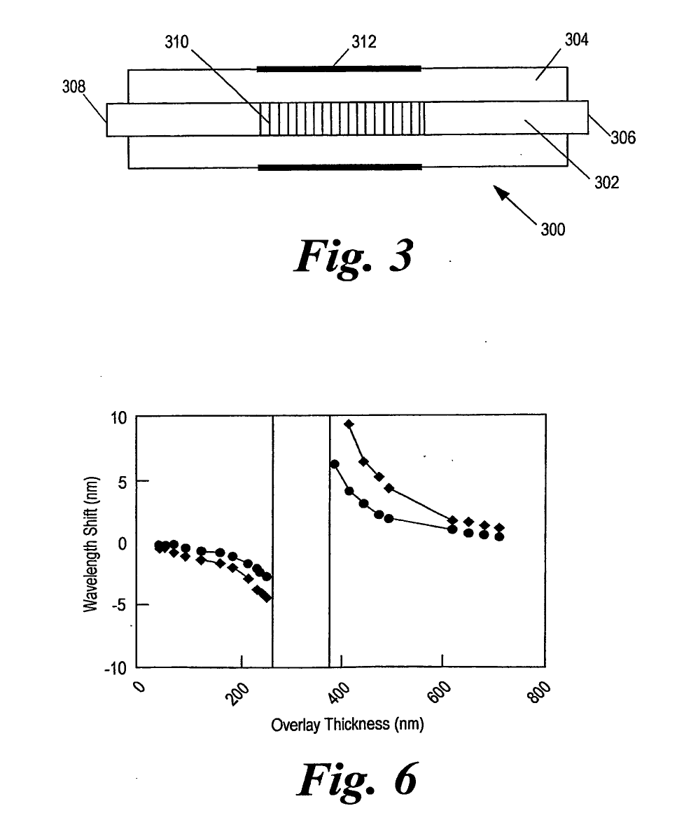

FIG. 3 is a schematic diagram of an embodiment of an optical transmission device according to the present invention;

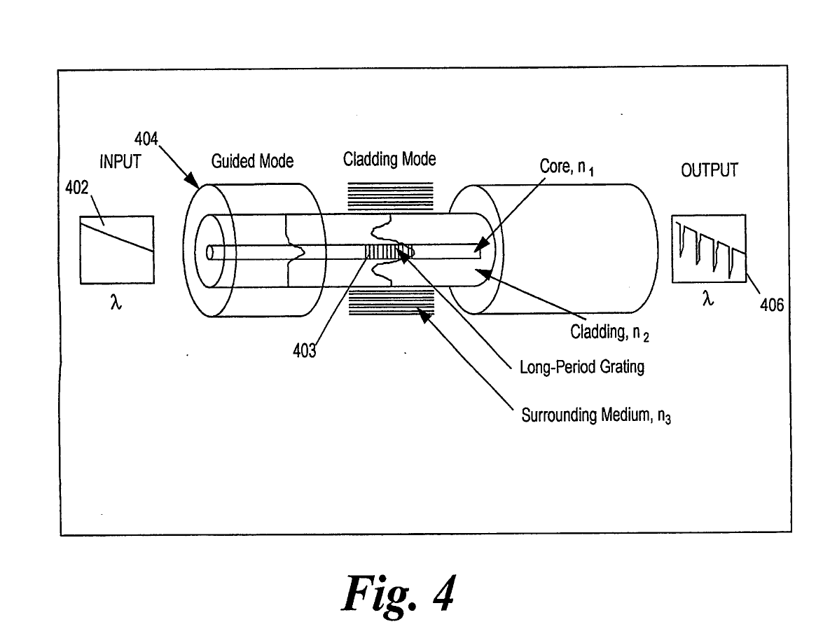

FIG. 4 is of an experimental configuration, showing the LPG within the optical fibre;

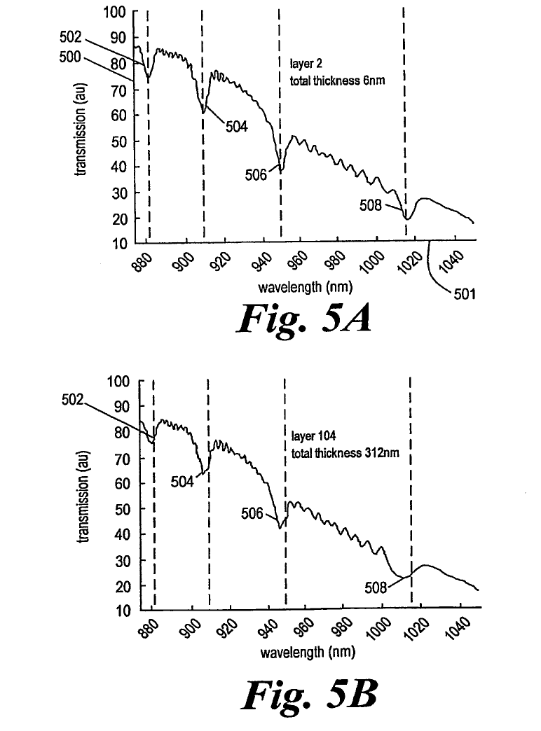

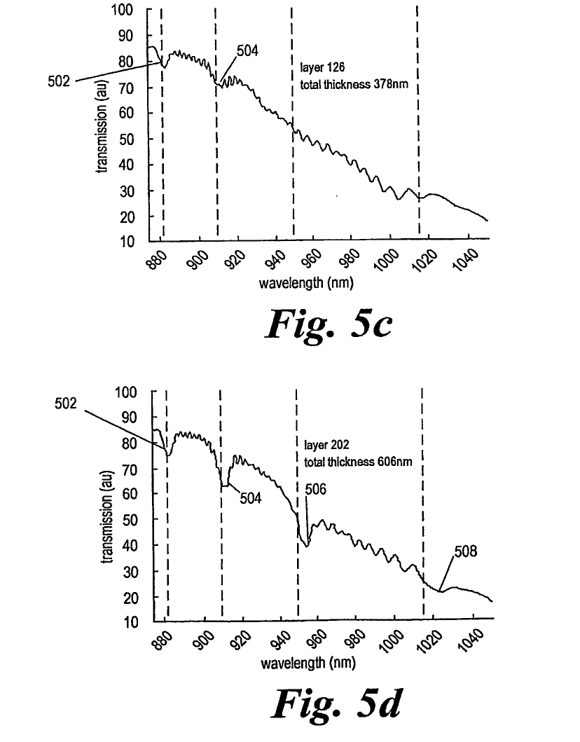

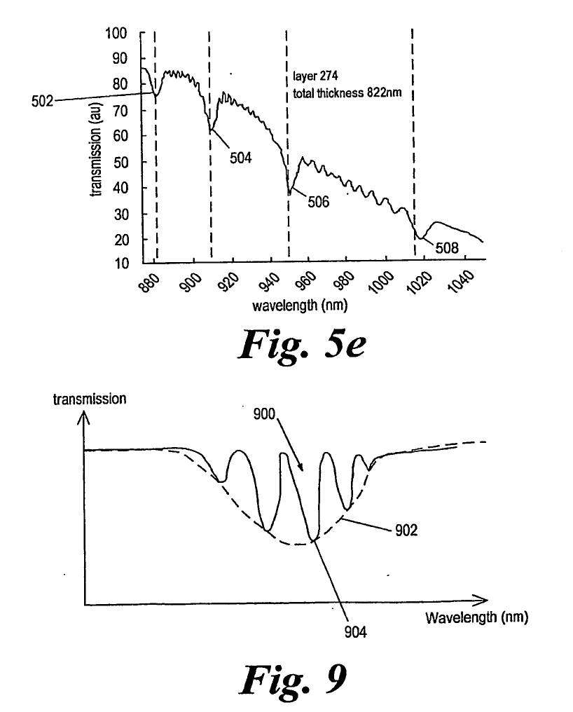

FIG. 5a is a reference spectrum showing attenuation bands of an optical fibre with a LPG present, with the presence of an overlayer of tricosenoic acid of minimal thickness (6 nm);

FIGS. 5b-5e are spectra showing the position of attenuation bands of an optical fibre with a LPG present, each with an overlayer of tricosenoic acid of respectively increasing thickness (312 nm, 378 nm, 606 nm, 822 nm);

FIG. 6 is a graph showing experimental shift in the central wavelengths the attenuation bands plotted as a function of the thickness of the overlay film; filled circles corresponding to coupling to the fifth cladding mode; filled squares, attenuation band corresponding to coupling to the sixth cladding mode;

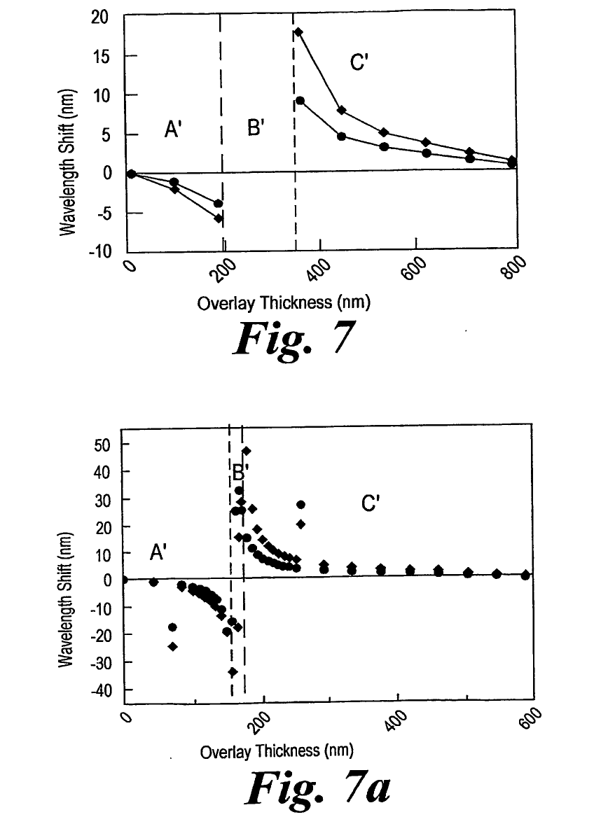

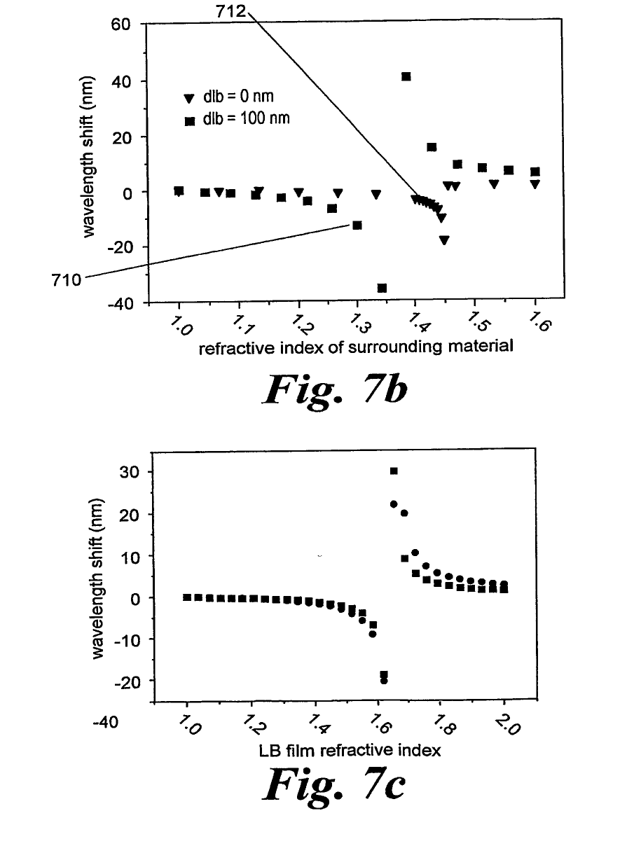

FIG. 7 is a graph showing theoretically predicted wavelength shifts in the central wavelength of attenuation bands plotted as a function of the thickness of an overlay film of refractive index 1.57; filled circles, attenuation band corresponding to the fifth cladding mode; filled squares, attenuation band corresponding to coupling to the sixth cladding mode;

FIG. 7a is a graph showing theoretically predicted wavelength shifts in the central wavelength of attenuation bands plotted as a function of the thickness of an overlay film of refractive index 1.7; filled circles, attenuation band corresponding to the fifth cladding mode; filled squares, attenuation band corresponding to coupling to the sixth cladding mode;

FIG. 7b is a graph showing theoretically predicted wavelength shifts central wavelength of attenuation bands plotted as a function of the refractive index of a surrounding substance for no overlayer (filled triangles) and an overlayer thickness of 100 nm (filled squares) with a refractive index of 1.7;

FIG. 7c is a graph showing theoretically predicted wavelength shifts in the central wavelength of attenuation bands plotted as a function of the refractive index of an overlay film of thickness 200 nm; filled circles, attenuation band corresponding to the fifth cladding mode; filled squares, attenuation band corresponding to coupling to the sixth cladding mode;

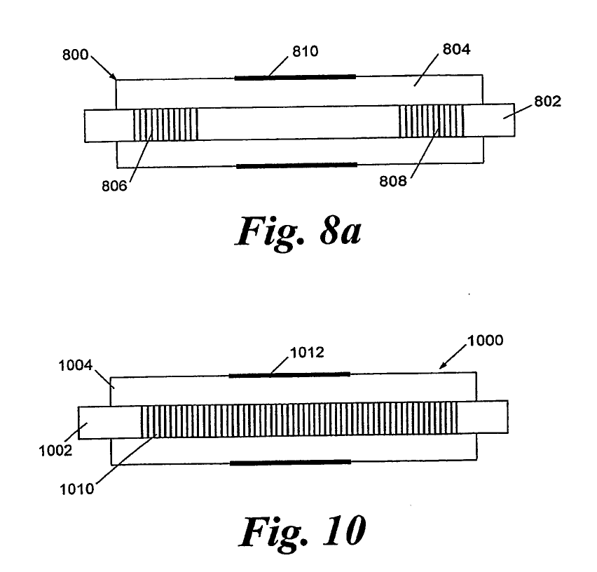

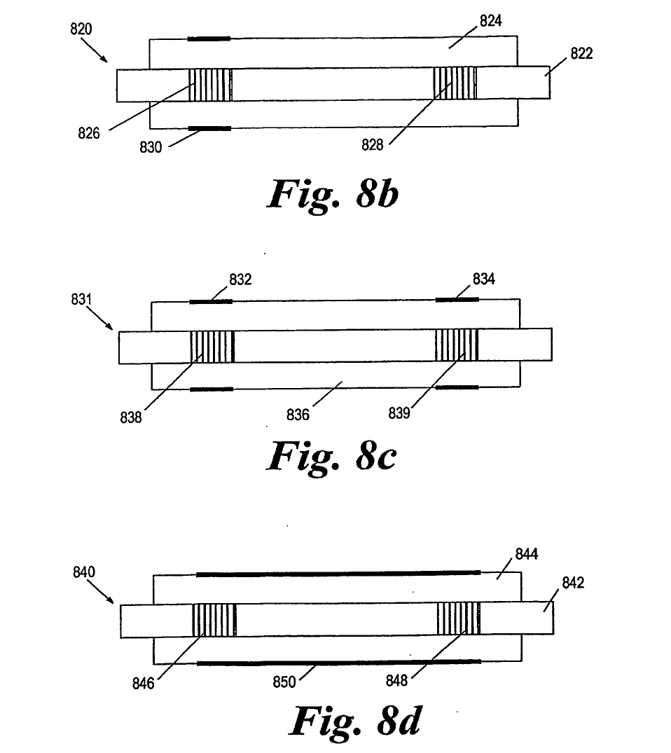

FIG. 8a is an alternative embodiment of an optical transmission device according to the present invention;

FIG. 8b is another alternative embodiment of an optical transmission device according to the present invention;

FIG. 8c is yet another alternative embodiment of an optical transmission device according to the present invention;

FIG. 8d is a yet further alternative embodiment of an optical transmission device according to the present invention;

FIG. 9 is a representation of an attenuation band associated with at least one of the devices of FIGS. 8a to 8c;

FIG. 10 is a yet further alternative embodiment of an optical transmission device according to the present invention;

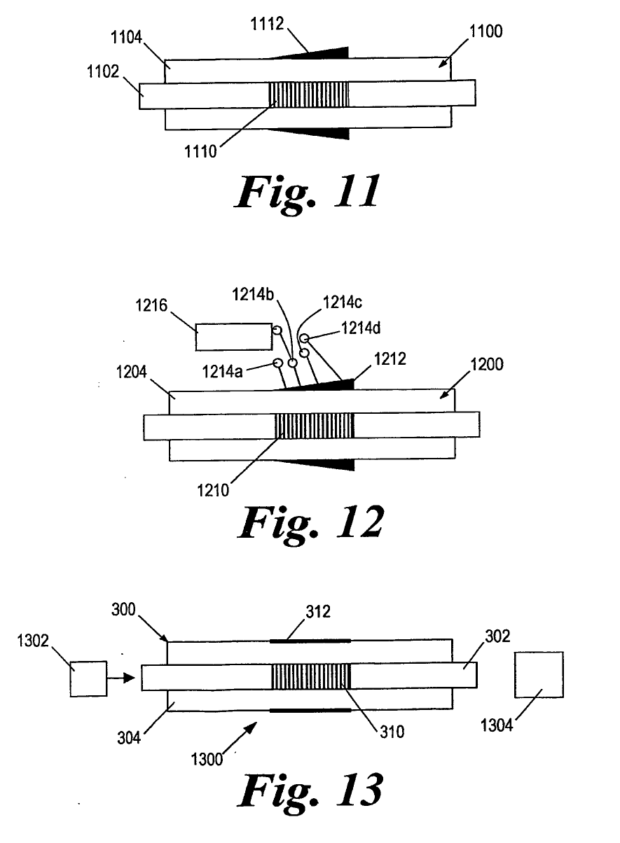

FIG. 11 is a still further alternative embodiment of an optical transmission device according to the present invention;

FIG. 12 is a yet another alternative embodiment of an optical transmission device according to the present invention;

FIG. 13 is a schematic diagram of a sensor including an optical transmission device according to an embodiment of an aspect of the present invention;

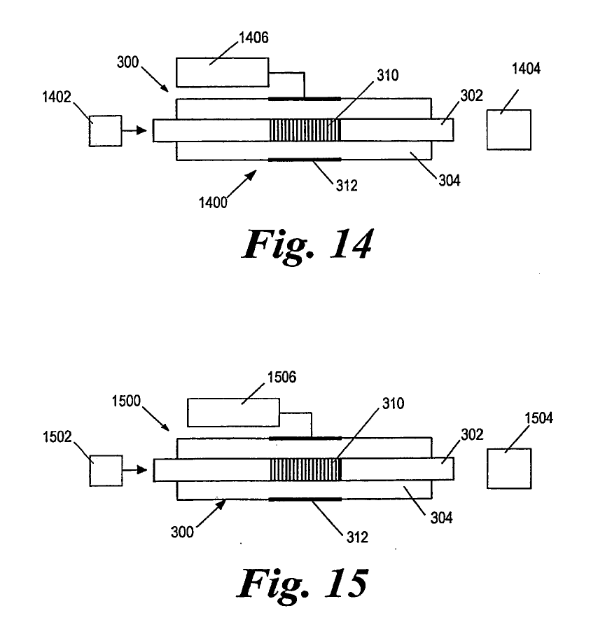

FIG. 14 is a schematic diagram of a reactive filter including the optical transmission device according to an embodiment of an aspect of the present invention; and

FIG. 15 is a schematic diagram of an optical modulator including an optical transmission device according to an embodiment of an aspect of the present invention.

Referring now to FIG. 3, an optical transmission device 300, typically a waveguide or an optic fibre, comprises a core 302, a cladding 304 having a refractive index that is larger than that of the core 302, which surrounds the core 302 such that ends 306,408 of the core are exposed to allow injection and collection of radiation from the core 302.

The core 302 has a long period grating (LPG) 310 patterned therein, the LPG typically has a length of 30 mm and a typical periodicity of between 100 μm-1000 μm but can have a larger or a smaller periodicity than this. The cladding 304 has a thin film overlayer 312 deposited thereupon, typically having a thickness between 2 nm and 822 nm and a refractive index in excess of that of silica 1.456. The LPG acts as a coupling means.

There are a range of techniques for depositing thin films of materials onto the surface of an optical fibre, including ionic self-assembly, sputtering, dip coating, spin coating, pulsed laser deposition and evaporation.

The Langmuir-Blodgett (LB) technique was employed to demonstrate the concept, although the other techniques listed above may also be used. The LB technique allows the deposition of thin films of organic materials onto substrates molecular layer by molecular layer at room temperature, giving extremely accurate control over the film thickness. The technique may be readily adapted to facilitate uniform deposition of thin films onto a cylindrical structure such as an optical fiber. Previously we have shown that LB films can be deposited onto side-polished optical fibers to form overlay waveguides^{ix}. These have been shown to act as wavelength filters^{ix}, chemical sensors^{x} and to offer an effective method for generating waveguide second-harmonic generation in non-centrosymmetric films^{xi}. The invention may also operate with films deposited via the other techniques. It will be appreciated that the LB technique is equally applicable to planar substrates as well as cylindrical substrates.

The LB material, tricosenoic acid [CH₂═CH₂(CH₂)₂₀CO₂H], was spread from dilute chloroform solutions (0.1 mg ml⁻¹) onto the pure water subphase of one compartment of a Nima Technology LB trough (model 2410A), left for 10 min at ca. 20° C., and compressed at 0.5 cm² s⁻¹ (ca. 0.1% s⁻¹ of total surface area). Deposition was achieved at a surface pressure of 30 mN m⁻¹ and a rate of 10 mm min⁻¹. The fibre containing the LPG was oriented such that the dipping direction was aligned with the long axis of the fibre and was alternately raised and lowered through the floating monolayer at the air-water interface, using a modified dipper mechanism. By multiple passes through the film, this gave a Y-type structure in which the amphiphilic molecules pack head-to-head and tail-to-tail. Other materials may also be used including electro-optic materials, photo-chromic materials and piezoelectric materials.

Radiation is injected into the core 302 at one end 306 and is retained therein by total internal reflection at the interface between the core 302 and the cladding 304. The radiation impinges upon the LPG 310 and is coupled into the cladding 304 at wavelengths corresponding to attenuation bands. The presence of the overlayer 312 causes a shift in the wavelength of the centre of the attenuation bands. Incrementally increasing the thickness of a thin film overlay 312 surrounding the LPG 310 shows that the central wavelengths of the LPG attenuation bands exhibits a dependence on both the thickness and refractive index of an overlay material with refractive index higher than that of the cladding 304.

The experimental configuration is shown in FIG. 4. The transmission spectrum was monitored by coupling the output from a white light source 402 into the optical fibre 404 containing the LPG 403 (parameters as described previously), and coupling the output from the distal end of the fibre 404 into an optical spectrometer 406. A transmission spectrum was recorded after each bilayer had been deposited. It will be appreciated that it is not necessary to deposit a bilayer, a monolayer or multilayer may be used if an appropriate deposition technique is used.

Referring now to FIG. 5a, a plot of transmission in arbitrary units, along the ordinate axis 500, versus wavelength in nm, along the abscissa 501, for an optical transmission device as described hereinbefore with refererence to FIG. 3, exhibits attenuation bands 502-508. These wavelengths of the attenuation bands 502-508 in this arrangement are used as reference values for the calculation of the change of position of the attenuation bands 502-508 within the spectrum as overlayer thickness is increased.

Referring now to FIG. 5b, the overlayer thickness is increased to 312 nm the position of the attenuation bands 502-508 is seen to shift towards lower wavelengths, typically by approximately 5 nm. The magnitude of the shift is typically dependent upon the order of the cladding mode, higher order modes being shifted more than lower order modes.

Referring now to FIG. 5c, the thickness of the overlayer has been increased to 378 nm and the attenuation bands 502-508 have effectively been suppressed.

Referring now to FIG. 5d, as the thickness of the overlayer is increased still further to 606 nm a shift in the positions of the attenuation bands 502-508 to higher wavelengths, typically of 5 nm, is observed. Again the effect is typically more pronounced for higher order cladding modes than for lower order modes.

Referring now to FIG. 5e, the positions of the attenuation bands 502-508 return towards their reference values as the thickness of the overlayer is increased still further to 822 nm.

FIG. 6 shows the experimentally determined shift in the central wavelengths of the attenuation bands 506, 508 corresponding to coupling to the 5^{th} and 6^{th} cladding modes plotted as a function of the thickness of the film 312. The graph contains three distinct regions A,B,C characterized by differences in the form and response of the transmission spectrum. The graph shows that for an overlay thickness of less than 300 nm, (region A), the attenuation band 506,508 shows a wavelength shift of ˜10 nm. For an overlay thickness of between 300 nm and 450 mn, (region B), the amplitude of the attenuation bands 506,508 in the transmission spectrum reduced to zero and thus no coupling wavelengths could be recorded. For an overlay thickness of over 500 nm, (region C), the attenuation bands 506,508 reappeared, but at a wavelength higher than originally observed in the absence of the overlay material. As the film thickness was increased further, the central wavelengths of the attenuation band 506,508 returned towards their original value.

The exact thickness of the overlay 312 required to achieve these effects is dependent upon the refractive index of the material, and for a particular overlay thickness, changes in the refractive index of the overlay material result in shifts the central wavelengths of the attenuation bands. The position of the attenuation bands 502-508 is also dependent upon the refractive indices and dimensions of the core 302 and the cladding 304.

A model has been developed to determine the dependence of the central wavelengths of the attenuation bands 502-508 upon the thickness and refractive index of the overlay 312. The effective refractive indices of the cladding modes were calculated as a function of wavelength and overlay thickness by considering the cladding/overlay system as a stack of thin films and employing the transfer matrix methods. The effective refractive index of the propagating core mode was calculated using the approach of Gloge^{xiii}. Using the calculated dispersion of the core and cladding modes in Equation 1, the central wavelengths of the LPG attenuation bands 502-508 could be determined as a function of overlay thickness. The model predicts the form of the dependence of the attenuation bands' central wavelengths upon overlay thickness, as is shown in FIG. 7. In agreement with the experimental observations, three distinct regimes A′,B′,C′ are predicted. The model makes a number of approximations, in particular that the system may be modeled as a multilayer planar waveguide. The model qualitatively predicts the experimentally observed behaviour, and discrepancies in the predicted values could arise from the approximations made, and the accuracy of the knowledge of the fiber and overlay material parameters.

Referring now to FIG. 7a, the transitions between region A′ and B′, and regions B′ and C′ is shown to shift to a lower thickness of overlayer as the refractive index of the overlayer increases, compare FIGS. 7, 7a.

Referring now to FIG. 7b the position of peak sensitivity of the attenuation band wavelength shift can be tuned to the refractive index of a substance surrounding the whole optical transmission device by the deposition of an overlayer of a high refractive index material, typically a few hundred nm thick, (Plot 710) compared to the reference, no overlayer, case (Plot 712). This is of particular interest where the overlayer is inert and does not react with the substance into which it is immersed this allows the tuning down of the region of peak sensitivity down to a region of interest, for example in concentration measurements of glucose solutions.

Referring now to FIG. 7c, variation in the refractive index of an overlayer of constant thickness has a corollary effect to varying the thickness of an overlayer of constant refractive index.

The behaviour may be understood from the following qualitative discussion. Initially, only the surrounding air influences the effective index of the cladding mode. As the film becomes thicker, (region A), both the LB film 312 and the air influence the cladding mode, increasing the average external refractive index. As the average external refractive index experienced by the cladding modes increases, a negative shift in wavelength is seen, as would be expected from the response to immersion in refractive index oils, shown in FIG. 1.

In region B, the average external refractive index is approximately equal to that of the cladding 304. In this case, the cladding 304 is effectively infinite and supports no guided modes and hence no attenuation bands 502-508 are observed in the transmission spectrum.

In region C a more complex waveguide structure exists. The existence of cladding modes when the refractive index of the medium surrounding the fiber is higher than that of the cladding 304 has been previously explained by lealy modes that exist in such an inverted waveguide structure^{iv}. As the thickness of the LB film 312 increases further, the central wavelength of the attenuation bands 502-508 would be expected to tend to that which would be observed for an overlay 312 of infinite extent.

The wavelength shifts exhibited by materials with refractive indices higher than the cladding offer many new prospects for optical fiber sensors, modulators, tunable filters and optical switches.

Of particular interest is the transition from region A to region C, since this introduces a large wavelength shift for a small change in the optical thickness of the overlay 312. If a film 312 of appropriate thickness is deposited, then a small refractive index change, induced thermally, optically, electrically or chemically, dependent upon the overlay material used, could cause a large wavelength shift, offering the prospect of developing a highly sensitive sensor, or an optical modulator or an optical switch. All of the regions of the LPG response discussed previously may be used to form any of the proposed devices.

Referring now to FIGS. 8a to 8d and 9, an alternative embodiment of an optical transmission device 800 comprises a core 802, a cladding 804 substantially surrounding the core 802 over the length of the core 802. The core 802 has two identical LPG's 806, 808 fabricated therein that are spaced apart from each other. The cladding 804 has a thin film overlayer 810 on it's outer surface in a region between the LPG's 806,808.

Radiation propagating along the device is coupled into and out of the cladding modes at the LPG's 806,808 which causes interference effects within the device. These interference effects introduce fine structure 900 into an attenuation band envelope 902 associated with the device 800. This fine structure 900 can be characterised and the movement of a feature 904 within the fine structure 900 can be monitored in order to provide a high resolution optical sensor or filter.

Fine structure can also be induced in a transmission device 820 comprising a core 822 and cladding 824 with two spaced apart LPGs 826,828 and a single overlayer 830 upon the cladding adjacent only one LPG 826. Coupling into and out of the cladding modes occurs at the LPGs 826,828 at different wavelengths which causes interference effects leading to fine structure 900. This is because the wavelength of the attenuation band associated with the LPG 828 without an overlayer is fixed and the attenuation band associated with the LPG 826 with the overlayer 830 is shifted interference will occur provided that the respective attenuation bands overlap. The degree of overlap of the attenuation bands can be altered by using an overlayer material with a refractive index that varies in respect to a stimulus, for example, a chemical, electrical or optical stimulus. The degree of overlap of the attenuation bands determines the phase and amplitude of the fine structure 900 within the envelope 902. Thus, by altering the refractive index of the overlayer 830 the fine structure 900 can be altered, tuned.

Alternatively, an optical transmission device 831 can comprise two overlayers 832, 834 upon cladding 836 extending over each of LPGs 838, 839 but not therebetween. The overlayers 832, 834 need not be of the same material but can be of different materials. Additionally, or alternatively, the overlayers 832, 834 need not be of the same thickness. This allows the tuning of the wavelength shift of the attenuation modes associated with each of the LPGs 838,839 and thus tuning of the interference effects that produce the fine structure 900 as described hereinbefore.

An optical transmission device 840 comprises a core 842 and cladding 844 with two spaced apart LPGs 846,848 and a single overlayer 850 upon the cladding extending over both of the LPGs 846, 848 and a region 852 between the LPGs 846,848. The overlayer can be of varying composition along it's length in order to give regions within the overlayer having, for example, different refractive indices or thicknesses. Indeed the regions can be of different types of materials, photo-optic, electro-optic, chemical sensitive. The phase and amplitude of the fine structure 900 within the envelope 902 can be controlled as hereinbefore described.

Referring now to FIG. 10, an optical transmission device 1000 is substantially as described hereinbefore with reference to FIG. 3 and similar parts will be accorded the same reference numerals in the one thousand series. Overlayer 1012 extends only over a portion of cladding 1004 adjacent LPG 1010, typically a central portion of about 50% the length of the LPG 1010. This has the effect of introducing a phase shift into radiation coupled into the cladding 1004, which introduces fine structure into an attenuation band associated with the device 1000 similar to that shown hereinbefore with reference to FIG. 9.

Referring now to FIG. 11, an optical transmission device 1100 is substantially as described hereinbefore with reference to FIG. 3 and similar parts will be accorded the same reference numerals in the eleven hundred series. The thickness of overlayer 1112 varies along the length of LPG 1110. This has the effect that different wavelengths of light will be coupled into cladding 1114 at different points along the length of the LPG 1110. This has the effect of broadening attenuation bands associated with the device 1100.

Referring now to FIG. 12, an optical transmission device 1100 is substantially as described hereinbefore with reference to FIG. 3 and similar parts will be accorded the same reference numerals in the twelve hundred series. Overlayer 1212 is fabricated from an electro-optic material and has a number of electrodes 1214a-d attached thereto. The electrodes 1214a-d are connected to a switchable power supply 1216 such that an individual electrode 1214b can be addressed. The application of a voltage from the power supply to the addressed electrode 1214b induces a variation in the refractive index of the overlayer 1212 in the vicinity of the electrode 1214b. As noted hereinbefore a variation in refractive index has a similar effect to the variation of overlayer thickness and thus the coupling of radiation from core 1202 into cladding 1204 is affected in the vicinity of electrode 1214b.

Referring now to FIG. 13, a sensor arrangement 1300 comprises a radiation source 1302, a radiation detector 1304 and optical transmission device 300.

The radiation source 1302 emits radiation at wavelengths encompassing the attenuation bands of LPG 310—overlayer 312 arrangement. The radiation detector 1304 is arranged to monitor at least one of the attenuation bands of the LPG 310-312 overlayer arrangement.

The overlayer 312 can be photo-optic in which case the refractive index of the overlayer will vary in response to wavelength and/or intensity of incident light causing a shift in the monitored attenuation band. This will cause a signal to be output from the radiation detector to a processor, not shown.

Alternatively, the overlayer 312 can be electro-optic in which case the refractive index of the overlayer will vary in response to a voltage applied to the overlayer 312 light causing a shift in the monitored attenuation band. This will cause a signal to be output from the radiation detector to a processor, not shown. This is of particular utility in the power generation industry.

In a still further alternative, the overlayer 312 may be sensitive to the presence of a chemical species in which case the refractive index of the overlayer 312 will vary in response to the presence of said chemical species causing a shift in the monitored attenuation band. This will cause a signal to be output from the radiation detector to a processor, not shown. Typical species to be monitored include sulphur dioxide, toluene, ammonia, solvents, methane, pesticides, nitrates, glucose. Once the arrangement has been calibrated, typically by the use of a reference of known activity, both qualitative and quantitative measurements of chemical species are possible. The arrangement can be used with both liquids and gases, and can be used to test for the presence of ionic species in a liquid.

Similarly a thermo-optic material can be used for the overlayer in temperature sensing applications. The overlayer can be fabricated from a material that exhibits a variation in refractive index with varying pressure or humidity to produce pressure or humidity sensors.

Alternatively, the sensor arrangement 1300 may be arranged to generate a signal in response to changes in the physical dimensions of the overlayer which has a corollary effect to a change in refractive index, for example swelling of the film due to the effect of humidity.

Referring now to FIG. 14, a tunable filter 1400 comprises a signal source 1402, a signal receiver 1404, an optical transmission device 300 and a control input 1406.

The signal source 1402 injects a signal into the device 300 where it is shaped by use of the attenuation bands of the device 300 in removing wavelengths of radiation from the signal. The shaped signal is received by the signal receiver 1404. The control input 1406 is connected to overlayer 312 in order to control the position and magnitude of the attenuation bands of the device 300, and thus control the signal shaping function of the filter 1400.

The control input 1406 can be a signal representative the ambient temperature in order to provide a temperature compensated filter by positioning the attenuation bands such that a desired output signal profile is achieved at the receiver 1402 from an undesired input signal profile. For example, this is of importance in the case of fibre amplifiers, typically Er doped fibre amplifiers, where a flat response curve over a broad range of wavelengths is required and thermal fluctuations in the response of the fibre amplifier can degrade their performance.

Alternatively, or additionally, the control input can be representative of part of the input signal generation process. For example, Er dopes fibre amplifiers use a pump laser to pump the amplification means and a signal indicative of the state of the pump laser can be fed to the overlayer 312 so as to affect the attenuation bands so as to compensated for fluctuations in the pump laser output. The overlayer 312 can be photo-chromic in which case the signal may be portion of the laser output, tapped directly from the laser. Alternatively, the overlayer 312 may be electro-optic in which case the signal will be an electrical generated by a radiation sensor (not shown) upon which a portion of the laser radiation impinges.

Referring now to FIG. 15, an optical modulator 1500 comprises a signal source 1502, a signal receiver 1504, an optical transmission device 300 and a control input 1506.

The signal source 1502 injects a signal into the device 300 where it is modulated by use of the attenuation bands of the device 300. The control input 1506 is connected to overlayer 312 in order to control the position and magnitude of the attenuation bands of the device 300, and thus control the modulation of the signal passing along the device 300 of the filter 1500. The radiation detector 1504 is arranged to monitor at least one of the attenuation bands of the LPG 310-312 overlayer arrangement.

The overlayer 312 can be photo-optic in which case the control input 1506 is optical. The refractive index of the overlayer will vary in response to wavelength and/or intensity of incident light from the control input 1506 causing a shift in the monitored attenuation band. This will cause a change in the signal received at the receiver 1504. This signal can correspond to the transition between region A to region B of FIG. 7 or the transition between region C to region B of FIG. 7. Alternatively, the signal can correspond to an increased, or decreased, transmission as the attenuation band shifts in wavelength dependent upon whether the receiver 1504 is monitoring the attenuation band or adjacent the attenuation band respectively. Attenuation bands can result in 0% transmission.

Alternatively, the overlayer 312 can be electro-optic in which case the control input will be electrical. The refractive index of the overlayer will vary in response to a voltage applied to the overlayer 312 from the control input causing a shift in the monitored attenuation band. This will cause a change in the signal received at the receiver 1504. This signal can correspond to the transition between region A to region B of FIG. 7 or the transition between region C to region B of FIG. 7. Alternatively, the signal can correspond to an increased, or decreased, transmission as the attenuation band shifts in wavelength dependent upon whether the receiver 1504 is monitoring the attenuation band or adjacent the attenuation band respectively.

It will be appreciated that the present invention is applicable to in mode locking in the generation of a pulsed laser output. Light coupled into the cladding 304 from the core 302 can vary the refractive index of a photo-chromic overlayer so as to shift an attenuation band at the laser wavelength away from the laser wavelength. This allows laser action to occur. Once laser action has occurred the photo-chromic overlayer relaxes to it's original state and the attenuation band once again resides at the laser wavelength.

It will further be appreciated that the overlayer 312 can act as a waveguide if the material has non-linear optical properties, for example in second harmonic generation.

It will be appreciated that although described with reference to the embodiment of FIG. 3 any of the sensor, filter, modulator, phase locking or second harmonic generation applications described herein before can be achieved using any of the embodiments of the present invention described hereinbefore.

Depositing materials with different properties on neighboring sections of the same LPG 310 could be used to allow a single attenuation band 504 to be controllably split into a number of attenuation bands, allowing the switching of multiple wavelengths, or to change the shape of the attenuation band 504, which could be used to control the gain spectrum of an optical amplifier. This may also be achieved by fabricating a number of spatially distinct LPGs with different periods and/or different overlay materials.

By placing LPGs fabricated in separate optical fibres in close proximity, light may be coupled from one fibre to another at wavelengths determined by the properties of the LPGs. Coating one or both of the LPGs with the thin film overlays would allow active control over the coupling wavelength, allowing the development of an optical switch, router, modulator, tunable.

### APPENDIX A

### Literature Referred to in the Application

ⁱ D. M. Costantini, C. A. P. Muller, S. A. Vasiliev, H. G. Limberger, and R. P. Salathe, Tunable loss filter based on metal-coated long-periodfiber grating IEEE Photonics Technol. Lett.11, pp 1458-1460 (1999)

ⁱⁱ V. Bhatia, A. M. Optical fiber long-period grating sensors Opt. Lett. 21, pp 692-694 (1996).

ⁱⁱⁱ C. C. Ye, S. W. James, and R. P. Tatam, Simultaneous temperature and bend sensing with long-period fiber gratings Opt.Lett. 25, pp 1007-1009 (2000).

^{iv} H. J. Patrick, A. D. Kersey and F. Bucholtz, Analysis of the response of long period fiber gratings to external index of refraction. J. Lightwave Technol. 16, pp1606-1611 (1998)

^{v} S. Khaliq, S. W. James and R. P. Tatam, Liquid level sensing using optical fiber long period gratings, in press, Opt.Lett. (2001).

^{vi} R. Falciai, A. G. Mignani and A. Vannini, Long period gratings as solution concentration sensors Sensors And Actuators B-Chemical pp 74-77, 74, 2001

^{vii} J. N. Jang, S. Y. Kim, S. W. Kim, M. S. Kim, Temperature insensitive long-periodfiber gratings Electron. Lett. 35, pp 2134-2136 (1999)

^{viii} Z. Zhang, M. Shiloach, S. Pilevar, C. C. Davis, J. Sirkis and Bentley, Evanescent wave long period fiber Bragg grating as an immobilized antibody biosensor. Anal. Chem. 72, pp 2895-2900, (2000).

^{ix} R. B. Charters, A. P. Kuczynski, S. E. Staines, R. P. Tatam and G. J. Ashwell, In-line fiber-optic channel dropping filter using Langmuir-Blodgett films, Electron.Lett. 30, pp594-596 (1994).

^{x} D. Flannery, S. W. James, R. P. Tatam and G. J. Ashwell, Fiber optic chemical sensing with LB overlay waveguides, Appl.Opt. 38, pp7370-7374 (1999).

^{xi} S. S. Johal, S. W. James, R. P. Tatam and G. J. Ashwell, Second-harmonic generation in Langmuir Blodgett waveguide overlays on single mode fibers, Opt.Lett. 24, pp 1194-1196 (1999).

xii A. K. Ghansk, K, Thyagarajan and M. R. Shenoy, Numerical analysis of planar optical waveguides using a matrix approach, IEEE J. Lightwave Technol. LT-5, pp660-667 (1987).

xiii D. Gloge, Weakly guiding fibers Appl.Opt. 10, pp2252-2258 (1971)

1. An optical transmission device comprising a core and a cladding, the cladding substantially enclosing the core over substantially all of the length of the core, the core being arranged to transmit radiation therealong and comprising coupling means therein arranged to selectively couple at least one wavelength of radiation into the cladding, an overlayer extending over at least a region of the cladding, the at least one wavelength of radiation arranged to be coupled into the cladding from the core varying as the thickness and/or refractive index of the overlayer is varied, the overlayer being sufficiently thin to allow the use of an overlayer with a refractive index higher than the refractive index of the cladding.

2. A device according to claim 1 wherein the coupling means is a long period grating.

3. A device according to either of claims 1 or 2 wherein the overlayer is located on an external face of the cladding adjacent the coupling means.

4. A device according to claim 3 wherein the overlayer extends over a fraction of the length of the coupling means.

5. A device according to either of claims 1 or 2 wherein there are two spaced apart coupling means.

6. A device according to claim 5 wherein the overlayer is located on an external face of the cladding between the two spaced apart coupling means.

7. A device according to any preceding claim 6 wherein the combination of the overlayer and surrounding environment have a different effective refractive index to the refractive index of the cladding.

8. A device according to claim 7 wherein the combination of the overlayer and surrounding environment have a refractive index that is less than that of the cladding.

9. A device according to claim 8 wherein the coupling means is arranged to couple the at least one wavelength of radiation coupled into the cladding from the core that is shifted to a lower wavelength than a wavelength of radiation that is coupled into the cladding from the core in the absence of the overlayer.

10. A device according to claim 7 wherein the combination of the overlayer and surrounding environment have a refractive index that is more than that of the cladding.

11. A device according to claim 10 wherein the coupling means is arranged to couple the at least one wavelength of radiation coupled into the cladding from the core that is shifted to a higher wavelength than a wavelength of radiation that is coupled into the cladding from the core in the absence of the overlayer.

12. A device according to any preceding claim 10 wherein the overlayer has a refractive index that varies in response to any one, or combination, of the following: temperature, presence of at least one chemical species, an applied electric field, externally applied radiation, the transmitted radiation, humidity, pressure.

13. A device according to any preceding claim 10 wherein the thickness of the overlayer varies along the length of the cladding.

14. A device according to claim 13 wherein the overlayer is electro-optic and has a number of electrical contacts thereto, each of which is operable to apply a voltage to overlayer at a particular location.

15. A device according to any preceding claim 14 wherein the overlayer is deposited by any one, or combination, of the following: Langmuir-Blodgett deposition, ionic self-assembly, sputtering, dip coating, spin coating, pulsed laser deposition, evaporation.

16. A sensor including a device according to any one of claims 1 to 15.

17. A sensing arrangement including a radiation source, a radiation detector and a sensor according to claim 16, the radiation source being arranged to emit radiation at the at least one wavelength of radiation and the radiation detector being arranged to detect radiation at the at least one wavelength of radiation.

18. A sensing arrangement according to claim 17 wherein the arrangement is arranged to generate an output signal in response to a threshold level being reached in respect of any one, or combination of the following: temperature, concentration of at least one chemical species, applied electric field strength, intensity of externally applied radiation, wavelength of externally applied radiation.

19. An optical modulator including a device according to any one of claims 1 to 15.

20. An optical modulation arrangement including a radiation source, a radiation detector and an optical modulator according to claim 19, the radiation source being arranged to emit radiation at the at least one wavelength of radiation and the radiation detector being arranged to detect radiation at the at least one wavelength of radiation.

21. An optical modulation arrangement according to claim 20 wherein the optical modulator is arranged to switch state in response to a signal indicative of any one, or combination of the following: temperature, presence of at least one chemical species, an applied electric field, externally applied radiation.

22. A tuneable filter including an optical transmission device according to any one of claims 1 to 15.

23. A tuneable filter according to claim 22 wherein a control input representative of part of the input signal generation process at least partly determines a shaping function of the filter.

24. A tuneable filter according to either of claims 22 or 23 wherein a control input indicative of ambient temperature at least partly determines a shaping function of the filter.

26. An optical waveguide including an optical transmission device according to any one of claims 1 to 15.

26. An optical waveguide according to claim 25 wherein the optical waveguide is an optical fibre.

27. A method of coupling radiation from a core of an optical transmission device into a cladding of the device comprising the steps of:
v) enclosing the core in the cladding over substantially all of the length of the core;
vi) transmitting radiation along the core;
vii) coupling at least one wavelength of radiation into the cladding from the core using coupling means; and
viii) providing an overlayer that extends over a region of the cladding such that the at least one wavelength of radiation varies as the thickness and/or refractive index of the overlayer varies, the overlayer being sufficiently thin to allow the use of an overlayer with a refractive index higher than the refractive index of the cladding.
